(19) United States
(12) Patent Application Publication
(10) Pub. No.: US 2008/0205666 A1
(43) Pub. Date: Aug. 28, 2008

(54) Device For Processing Audio Data, A Method Of Processing Audio Data, A Program Element And A Computer-Readable Medium

(75) Inventor: Loic Bernard Tanghe, Schaerbeek (BE)

Correspondence Address: PHILIPS INTELLECTUAL PROPERTY & STANDARDS, P.O. BOX 3001, BRIARCLIFF MANOR, NY, 10510, US

(73) Assignee: Koninkljke Philips Electronics, N.V., Eindhoven (NL)

(21) Appl. No.: 11/908,139

(22) PCT Filed: Feb. 28, 2006
(86) PCT No.: PCT/IB06/50613

§ 371 Date: Sep. 10, 2007

(30) Foreign Application Priority Data
Mar. 15, 2005 (EP) 05102024.6

(51) Int. Cl. H04R 3/00

(52) U.S. Cl. 381/98

(57) ABSTRACT

A device (100) for processing audio data (101), wherein the device (100) comprises an uplifting means (102) adapted for uplifting a low-frequency component of the audio data (101), and an adjustment means (109) adapted for selectively adjusting an attenuation of the low-frequency component of the audio data (101).

### FIELD OF THE INVENTION

The invention relates to a device for processing audio data.
Beyond this, the invention relates to a method of processing audio data.
Moreover, the invention relates to a program element.
Furthermore, the invention relates to a computer-readable medium.

### BACKGROUND OF THE INVENTION

Portable devices become more and more important. Particularly, an increasing number of users buy hard disk based portable audio/video players, powerful and intelligent cellular phones, and other portable entertainment equipment.

One feature of electronic entertainment devices according to the prior art is the opportunity to adjust characteristics of an audible reproduction of audio data in a user-defined manner, for instance via a user-controllable volume control or a user-controllable equalizer.

Such features are integrated in known portable audio players. For instance, in the case of a battery-operated CD player or solid-state player, sound features like equalization or bass boost may be adjusted by a user to its preference via knobs or buttons provided on the audio player.

For instance, the R200 headphones of Koss™ include a cord equipped with an ambience enhancement circuitry. Such an ambience enhancement, which may be adjusted in a user-defined manner, may be created by electrical cross talk, that is to say by a mix of signals originating from the left channel and from the right channel. An ambience enhancement technology is disclosed in U.S. Pat. No. 3,924,072.

Cord with built-in volume-control functionality is realized for instance in in-ear headphones product SBC HE280 of Philips™.

U.S. Pat. No. 3,984,885 discloses four-channel headphones including sound insulating means between front and rear channel driver units, and tone control means only for the front channel tones. The sound insulating means are formed of foam material transmitting low pitched-tones and absorbing high-pitched tones. Knobs are provided on the headphones for operating variable resistors for tone control and for adjusting the balance.

### OBJECT AND SUMMARY OF THE INVENTION

It is an object of the invention to provide a system for processing audio data that is convenient to use and which system can be manufactured with low costs.

In order to achieve the object defined above, a device for processing audio data, a method of processing audio data, a program element and a computer-readable medium according to the independent claims are provided.

According to an exemplary embodiment of the invention, a device for processing audio data is provided, comprising an uplifting means adapted for uplifting a low-frequency component of the audio data, and an adjustment means adapted for selectively adjusting an attenuation of the low-frequency component of the audio data.

Furthermore, according to another exemplary embodiment of the invention, a method of processing audio data is provided comprising the steps of uplifting a low-frequency component of the audio data, and selectively adjusting an attenuation of the low-frequency component of the audio data.

Beyond this, according to another exemplary embodiment of the invention, a computer-readable medium is provided, in which a computer program of processing audio data is stored, which computer program, when being executed by a processor, is adapted to control or carry out the above-mentioned method steps.

Moreover, a program element of processing audio data is provided according to still another exemplary embodiment of the invention, which program element, when being executed by a processor, is adapted to control or carry out the above-mentioned method steps.

Processing audio data according to the invention can be realized by a computer program, that is to say by software, or by using one or more special electronic optimization circuits, that is to say in hardware, or in hybrid form, that is to say by means of software components and hardware components.

The characterizing features according to the invention particularly have the advantage that a system for processing audio data is provided which combines a permanent uplifting of a bass component of supplied audio data with a variable user-adjustable attenuation of the bass component. Thus, the system according to the invention manipulates only a low-frequency or bass component of the audio data (for instance only the contribution of frequencies below 500 Hz or below 200 Hz), wherein a high-frequency or treble component of the audio data (for instance only the contribution of frequencies above 500 Hz or above 200 Hz) is free from a manipulation. As a result, selectively activatable or deactivatable bass boost functionality is provided than can be activated by (at least partially) deactivating the attenuation, and that can be deactivated by (at least partially) activating the attenuation.

In other words, low-frequency components of provided audio data may be uplifted permanently, and when a user attenuates the low-frequency components to almost the same extent, this has the a consequence that almost no boost feature is audible. In a complementary scenario, when a user adjusts the adjustment means in a manner that an attenuation of the low-frequency component occurs, then, as a consequence of the uplifting of the low-frequency component of audio data, bass boost functionality is realized.

Thus, a device with an adjustable bass boost feature is created without the need to include expensive and power-hungry active electronics components, but which can be manufactured purely on the basis of cheap passive electronics components, which passive electronics components do not need any specially dedicated energy source.

The term “passive electronics” particularly relates to electronic members that do not include any active amplifying elements requiring a separate energy supply unit. A regulator of a passive electronics member may attenuate a signal, but is not capable of actively amplifying such a signal.

In contrast to this, the term “active electronics” particularly relates to electronic members that may both actively attenuate or amplify audio data.

The term “bass boost” particularly denotes some kind of amplification function that selectively amplifies audio components in a low frequency range, that is to say in the bass region. In other words, bass boost functionality increases an amplitude ratio between low frequencies and high frequencies to emphasize the bass contribution.

The term “bass cut” particularly denotes a function (for instance realized by an appropriate frequency filter) for frequency-specifically suppressing or eliminating low frequency components of audio data. A bass cut can be realized, for instance, by providing a physical switch on a microphone that filters out low frequencies.

According to one aspect of the invention, headphones may be provided with a bass boost functionality using exclusively passive electronics components. For this purpose, a headphone may be designed together with a passive electrical circuit to realize a controllable bass boost feature. Conventionally, with a passive electrical circuit, it is not possible to generate a boost, but it is easily possible to generate a bass cut. However, by a careful acoustical design it is possible to give headphones an uplift essentially exclusively at low frequencies (without essentially affecting the sensitivity of the headphone at other frequencies in a mid-frequency range and/or in a high-frequency range). A combination of the electrical bass cut and the acoustical bass uplift generates a flat acoustic response. To activate the boost function, a user may simply disable the electrical bass cut, for instance by operating a knob or a button. The remaining response is a headphone with a bass uplift.

In the system according to the invention, electronics and acoustics may be designed together. The response of the combined bass uplift/bass cut headphones provides a controllable bass boost function, since the default audio player frequency response is flat.

According to the invention, bass boost functionality can be provided integrated in the headphones, and does not necessarily be implemented in the audio player, in contrast to the prior art. Thus, according to the invention, problems resulting from a mismatch with the headphones frequency response (a typical mismatch leads to exaggerated low/mid frequencies and a “muddy” sound) are overcome. Such problems result from providing the bass boost function in the player, and not in the headphones.

By providing the bass boost feature in a device for processing and reproducing audio data, the bass boost feature is placed at a location which is convenient for a user to access, for instance in the cord of the headphones or in the earshell of the headphones. In contrast to this, when providing a user interface for adjusting the bass boost function at an audio player which is frequently carried in a pocket (for instance in the case of portable devices), an adjustment knob may be difficult to access for a user.

The system according to the invention having a device which may be realized as audio reproduction means like headphones or loudspeakers, has significant advantages compared to a bass boost functionality provided in an audio player, for instance in a portable player.

The system according to the invention has further significant advantages when realized as a passive electronic circuit. In contrast to a realization as an active electronics circuit (particularly in a battery powered manner), a passive electronic circuit is much cheaper. In an active circuit (like noise cancellation circuits), expensive components are active components like battery, operation amplifier, transistors. In the system according to the invention, which may be realized with passive electronics, a user may adjust a desired sound taste, and this in a manner which is cheap to manufacture: Capacitors and resistors as typical examples for passive electrical components have a price of typically less than 0.02 US $.

Since the system according to the invention can be implemented as a product compatible with all audio equipment with headphones output, there is no need for a special connector or power supply unit. This further contributes to the cost-efficient manufacturability of the device according to the invention.

For simply switching the bass boost function “on” or “off”, a switch may be provided in the electrical circuitry or in the software realization of the device, wherein a user may define via a user interface (a knob or a button) whether the switch is “on” or “off”.

Instead of such a simple “on”/“off” decision allowing a user to choose between the operation states “bass boost yes” and “bass boost no”, a refined electrical configuration can be implemented in the device allowing a user to control the extent to which a bass boost function shall be activated. For instance, a potentiometer or a set of different resistors or the like may be connected in the circuit in a manner to offer the user a variety of different bass responses, in a stepless manner (for instance using a potentiometer) or in a stepped manner (for instance using a plurality of different resistors).

The bass cut may be realized with the help of a frequency dependent filter, for instance a shelving filter or a high-pass filter. A shelving filter has a filter functionality that is complementary to the headphone acoustic bass boost. However, it is possible to use other filters having different frequency responses, for instance a high pass filter.

An electrical mid frequency cut or a treble cut with a switch can be made as well. However, a preferred implementation of the system according to the invention includes a bass cut in the frame of implementing a bass boost function, since this uses the fact that an acoustic bass boost can be realized without affecting the global sensitivity of the headphone. The sensitivity of a headphone is primarily defined by the speaker driver high frequencies capabilities.

General, the device according to the invention is applicable to all headphones, particularly to those sold as accessories. A portable audio player may typically use a headphone as an embodiment of a device according to the invention. The device according to the invention can, for instance, be realized in the frame of an outdoor headphone system, which in many cases already has a built-in volume control in the cord.

According to one aspect of the invention, a system is provided comprising a headphone with bass uplift and an electrical circuit arrangement to optionally attenuate bass frequencies of an audio signal supplied to the headphone.

According to an exemplary embodiment, such an electrical circuit arrangement may be manufactured by means of a capacitor connected in series with a headphone driver to form a high pass filter or a shelving filter. The capacitor and the resistor can be selectively short circuited to disable the electrical cut. Consequently, a bass boost feature can be provided in headphones, wherein the bass boost feature is user-controllable and is arranged at a convenient location for the user, preferably in the headphones cord or in the headphones ear-shell.

One aspect of the invention can be seen in providing special headphones with an acoustic bass uplift functionality combined with a user-definable electrical bass cut functionality which may be realized with passive electrical components. According to such a system, the headphones may be provided with an exaggerated bass response, and an electrical bass cut which is feasible with passive components.

Concerning the bass uplift, that is to say the exaggerated bass response of the headphones, several opportunities are known by the person skilled in the art how to realize this. Advantageously, a headphone with exaggerated bass response can be manufactured without a significant loss of sensitivity, since headphone sensitivity is mainly given by the speaker driver sensitivity at high frequencies, wherein the bass can be tuned almost independently.

The system according to the invention thus allows manufacturing cheap headphones with bass control, but without a loss of sensitivity. Further, the electronic circuit of the system according to the invention may be realized using a shelving filter, which actually provides a kind of tone control with only one speaker driver.

A main field of application of the system according to the invention is processing audio data. However, this system can be embedded in a scenario in which, in addition to the audio data, further data are processed, for instance visual data. Thus, the invention can be realized in the frame of a video data processing system.

The term “device” may include a unit limited by a housing. However, a device may comprise a plurality of sub-devices, which sub-devices can be connected. For instance, a cord that can be detached from or attached to headphones may form a common device with the headphones.

Referring to the dependent claims, further exemplary embodiments of the invention will be described.

Next, exemplary embodiments of the device for processing audio data will be described. These embodiments may also be applied for the method of processing audio data, for the computer-readable medium and for the program element.

The device according to the invention may comprise a reproduction means for reproducing the processed audio data. In other words, input audio data are provided to the device, are processed by the uplifting means and by the adjustment means and are then provided as processed output audio data to the means for reproducing the processed audio data in a way to become audible for a human listener. Thus, the means for reproducing the processed audio data may be headphones or loudspeakers or the like.

Particularly, the device may be configured as a passive electrical circuit. According to this embodiment, the device is constituted by passive electrical components, that is to say electrical components that do not provide any active amplifying functionality. Thus, the device according to the invention may be provided without a separate battery or energy supply unit. Energy for operating the device may be provided by an audio player, which audio player also provides the audio data.

Particularly, the device may be adapted as a headphone. A headphone (also known as earphone, stereophone, headset) is any kind of transducer that receives an electrical signal from a media player or receiver and uses speakers placed in close proximity to the ears (hence the name earphone) to convert the signal into audible sound waves. Typical products to which headphones are attached include a portable audio/video player, a mobile phone, a CD player, a digital audio player (MP3 player), and a personal computer. A headphone unit may incorporate a radio receiver. Headphones may be cordless, using radio (that is to say analog FM, digital Bluetooth, WiFi) or infrared signals to communicate with a base unit. However, headphones may also communicate with a base station via a cord.

The device according to the invention may be adapted for being coupled electrically to a control device (or base station) for providing energy for operating the device and for providing the audio data. Such a control device may be, for instance, an audio player or a video player, which provides the device with the audio data and, optionally, with electrical energy needed to power the device.

In the device, the uplifting means may be realized as physical uplifting means adapted for uplifting a low-frequency component of audio data. According to this embodiment, the uplifting functionality is not fulfilled by an electrical amplification unit, but by a physical, structural or mechanical element, which element acts on the acoustic properties of the system in a manner to emphasize bass components compared to higher frequency components. Manipulating or adjusting the acoustic response characteristics of the device for processing and reproducing audio data may realize such a physical or mechanical means (element). Such a modification allows uplifting low-frequency components of audio data, that is to say audio data below a particular frequency threshold. This can be achieved, for instance, by realizing these physical means as an acoustic mass acting essentially on the low-frequency component of the audio data. When providing the physical means as an acoustic mass acting predominantly on low-frequency components, wherein high frequency components (treble) remain essentially unchanged, then this results in a selective amplification of the low-frequency components with respect to the higher frequency components. Generally, the uplifting means can be realized by taking any measure that results in a bump in the frequency curve so that low frequencies are emphasized.

The uplifting means may be realized as an acoustic mass acting predominantly on the low-frequency component of the audio data. In this context, predominantly means that the influence of the uplifting means is so that a ratio between amplitudes of low-frequency components and high frequency components of the audio data is increased as a consequence of a frequency dependent influence of the uplifting means on the audio data or signals.

Particularly, the uplifting means may be realized as a vent in the reproduction means for reproducing processed audio data. By providing a sufficiently large bass vent at the back of a speaker driver or in the housing at the back of a driver, a mechanical or physical bass uplift function can be achieved without loosing sensitivity. Such a vent can be realized as a hole or a tube provided in the device.

An increased bass response can be realized based on a combination of two different factors. Firstly, the enclosure between the ear and the speaker driver needs to be sealed. Any leakage will degrade the bass response. Secondly, the back of the driver determines the bass response. If it is completely closed, then the bass response is flat. The more open, the more bass is uplifted. The opening could be controlled via holes in the back of the driver, and those holes can be open or be controlled by an acoustic resistance (for instance with felt papers glued onto the holes). The openings can be on the driver frame itself or on the headphone back housing. A tube or long hole is an appropriate realization for an opening because it has a high mass so it will be “acoustically open” for very low frequencies, and “acoustically closed” for higher frequencies. Any opening at the back with or without felt paper has an acoustic mass property, so somehow it is acoustically a vent, though it does not look like it.

According to still another exemplary embodiment of the invention, the device may comprise a user interface adapted to allow a user to adjust an attenuation of the low-frequency component of the audio data. Such a user interface may include knobs or buttons, a keypad, a touchpad or any other kind of audiovisual interface. For instance, it is also possible that a user controls the bass boost functionality with his voice, for instance in the frame of a voice recognition system.

The adjustment means of the device may be adapted for selectively switching on or switching off an attenuation of the low-frequency component of the audio data. In other words, the user may simply decide whether the bass boost function shall be fully activated or shall be fully deactivated.

However, as an alternative to the previously described embodiment, the adjustment means may also be adapted for selecting an attenuation of the low-frequency component of the audio data in a stepless or in a stepped manner. In other words, the extent to which a bass boost feature occurs can be adjusted according to this embodiment of the invention in fine steps or in a stepless manner which allows to refine the adjustability of the bass boost function.

In the device according to the invention, the adjustment means may be realized as a high-pass filter or as a shelving filter. A shelving filter (or shelve filter) is a type of filter in which all frequencies above or below a selected frequency are affected. Low shelving affects all frequencies below the selected frequency, high shelving all those above it. A high-pass filter allows all frequency components above a predefined cut-off frequency to pass through essentially unaffected.

In a realization of the device as headphones, the device may comprise a cord and/or an ear-shell. In such an embodiment, the device may be configured such that the user interface is provided at (or integrated in) the cord or at (or integrated in) the ear-shell of the headphones. According this embodiment, the adjustment of the bass boost is provided at a location being convenient for a user, since the user has an easy access to the cord or the ear-shell of headphones. The user interface may be arranged alternatively on a portable audio player, which audio player is frequently carried within a pocket and may thus be more difficult to be accessed by a user. Via the user interface, a user in addition to the bass boost function, for instance a volume control or an additional equalizer function, may operate one or more further functions.

In a realization of the device as headphones, the device may comprise a cord and/or an ear-shell. In such an embodiment, the device may be configured such that the adjustment means is provided at (or integrated in) the cord or at (or integrated in) the ear-shell of the headphones. Thus, similar like the user interface, the components forming the adjustment means can also be provided in a cord or an ear-shell of the headphones.

The device according to the invention may be realized as one of the devices of the group consisting of a portable audio player, a portable video player, a head mounted display, a mobile phone, a body-worn device, a DVD player, a CD player, a harddisk-based media player, an internet radio device, a public entertainment device, and an MP3 player. Although the mentioned devices relate to the main fields of application of the invention, any other application is possible.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 schematically illustrates a headphone according to an exemplary embodiment of the invention,

FIG. 2 shows a frequency response of the headphones shown in FIG. 1,

FIG. 3 schematically illustrates a headphone according to an exemplary embodiment of the invention having a bass vent provided therein,

FIG. 4 shows a circuit diagram of a device according to an exemplary embodiment of the invention,

FIG. 5 shows a diagram illustrating a filter functionality according to the invention.

### DESCRIPTION OF EMBODIMENTS

The illustration in the drawing is schematically. In different drawings, similar or identical elements are provided with the same reference signs.

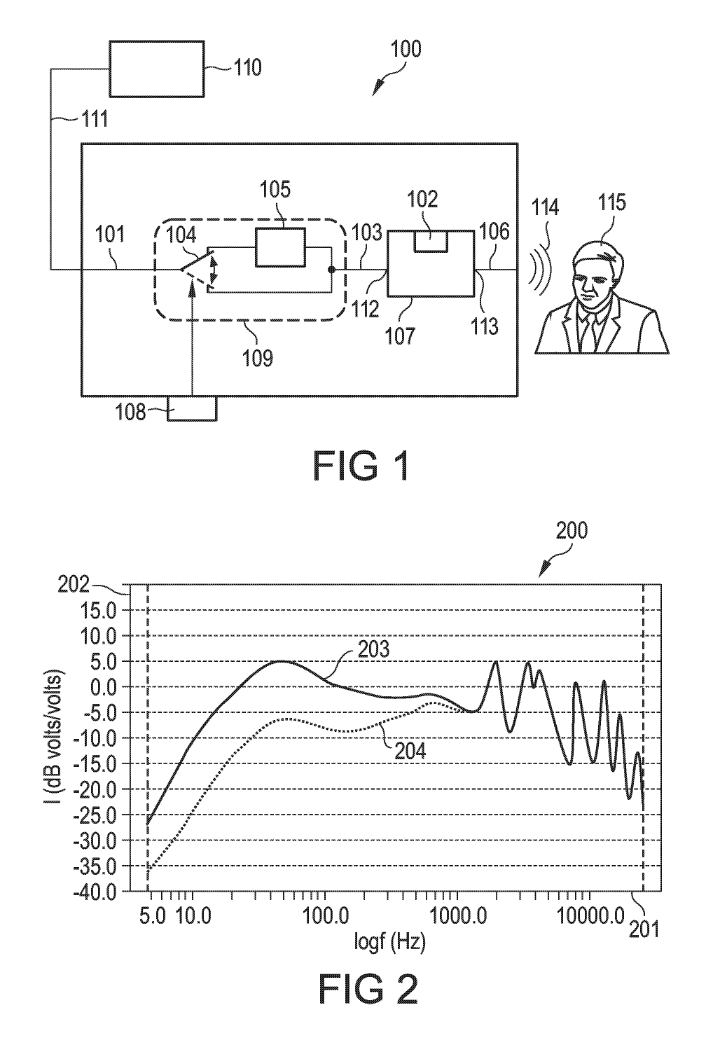

In the following, referring to FIG. 1, a schematic view of headphones 100 as a device for processing audio data according to an exemplary embodiment of the invention will be described.

Input audio data 101 are provided to the headphones 100 by an audio player 110 which may communicate with the headphones 100 via a cord 111 and which may provide energy for operating the headphones 100.

The headphones 100 comprise an acoustical mass 102 for uplifting a bass component of audio data, that is for selectively emphasizing low-frequency components of audio data compared with higher frequency components of audio data.

Further, the headphones 100 comprise adjustment means 109 adapted for selectively adjusting an attenuation of the low-frequency component of audio data. The adjustment means 109 comprise a switch 104 which may be operated by a user via a knob 108 provided on the headphones 100. The audio player 110 supplies input audio data 101 to the adjustment means 109.

In a first position of the switch 104 of the adjustment means 109 (as shown in FIG. 1), the input audio data 101 are guided through a shelving filter 105 before being supplied as partially processed audio data 103 to an acoustic output unit 107.

In a second switch 104 position (not shown in the figure), the input audio data 101 are directly guided as partially processed audio data 103 from the adjustment means 109 to the acoustic output unit 107 (a speaker or the like) for producing acoustic waves 114 audible for a human listener 115.

In other words, a user 115 may adjust the knob 108 to one of the two positions to switch “on” or switch “off” the attenuation of the low-frequency components of the audio data 103. When the switch 104 is in the first switch position as shown in FIG. 1, the acoustic uplift of bass components achieved by the acoustical mass 102 is at least partially compensated by the damping in the shelving filter 105. In contrast to this, when the switch 104 is in the second switch position, then the bass uplift is not compensated in the adjustment means 109, resulting in a bass boost of the data output via the acoustic output unit 107.

According to the described embodiment, the acoustic mass 102 is integrated in the acoustical output unit 107 of the headphones 100. In other words, the acoustical output unit 107 of the headphones 100 is an entity with an electrical input 112 and an acoustical output 113 with bass uplifted by the acoustic mass 102. The acoustical output unit 107 of the headphones 100 are realized as speakers with the acoustic mass 102 provided at the back thereof, for bass uplifting.

Summarizing the path of the audio signal to be processed, the input audio data 101 are provided at an input of the adjustment means 109 where a user-controlled attenuation of the bass component of the input audio data 101 may be adjusted, to generate partially processed audio data 103. The partially processed audio data 103 are supplied to the electrical input 112 of the acoustic output unit 107 having integrated an acoustical mass 102 which acts on the acoustical properties of the audio content to be played back in a manner that output audio data 106 having a bass uplift are provided at the acoustical output 113 of the acoustic output unit 107 to be audible as acoustic waves 114 by the human listener 115.

In the following, referring to FIG. 2, a diagram 200 will be described illustrating the frequency response of headphones according to the invention, measured on a Kemar™ dummy head.

Along an abscissa 201 of the diagram 200, a frequency of audio data is plotted on a logarithmic scale. Along an ordinate 202 of the diagram 200, the intensity of the audio data is plotted in dB.

The diagram 200 shows a first curve 203 and a second curve 204. The first curve relates to an operation state of the headphones 100 in which bass boost functionality is switched “on”. In other words, this operation state corresponds to the second switch position of the switch 104, in which the shelving filter 105 is bypassed so that the input audio data 101 are directly provided to the acoustic output unit 107. The original headphone response (designed to have a bass boost) is directly supplied to the acoustic output unit 107, and the electrical bass cut unit 109 is bypassed. The user hears a bass boosted response.

As shown on a second curve 204 of the diagram 200, there is a second operation mode in which the bass boost is switched “off”. According to this operation state, the switch 104 is brought by a user, via knob 108, to the first switch position shown in FIG. 1. According to this operation mode, the input audio data 101 are guided through the shelving filter 105 in which predominantly the low-frequency components of the audio data 101 are attenuated. In other words, according to the operation state related to the second curve 204, the acoustical bass uplift is now combined with the electrical bass cut. The user hears a flat acoustic response.

As can be seen from FIG. 2, the low-frequency range may be separated from the high-frequency range at something like 1000 Hz.

Alternative possibilities for realizing the bass uplift functionality provided by the acoustical mass 102 without loosing sensitivity is known to the skilled person in the technical field of headphones. The electrical bass cut realized by the shelving filter 105 may alternatively be realized using a high-pass filter, wherein a capacitor and/or a resistor of such a filter can be short-circuited to disable the electrical cut.

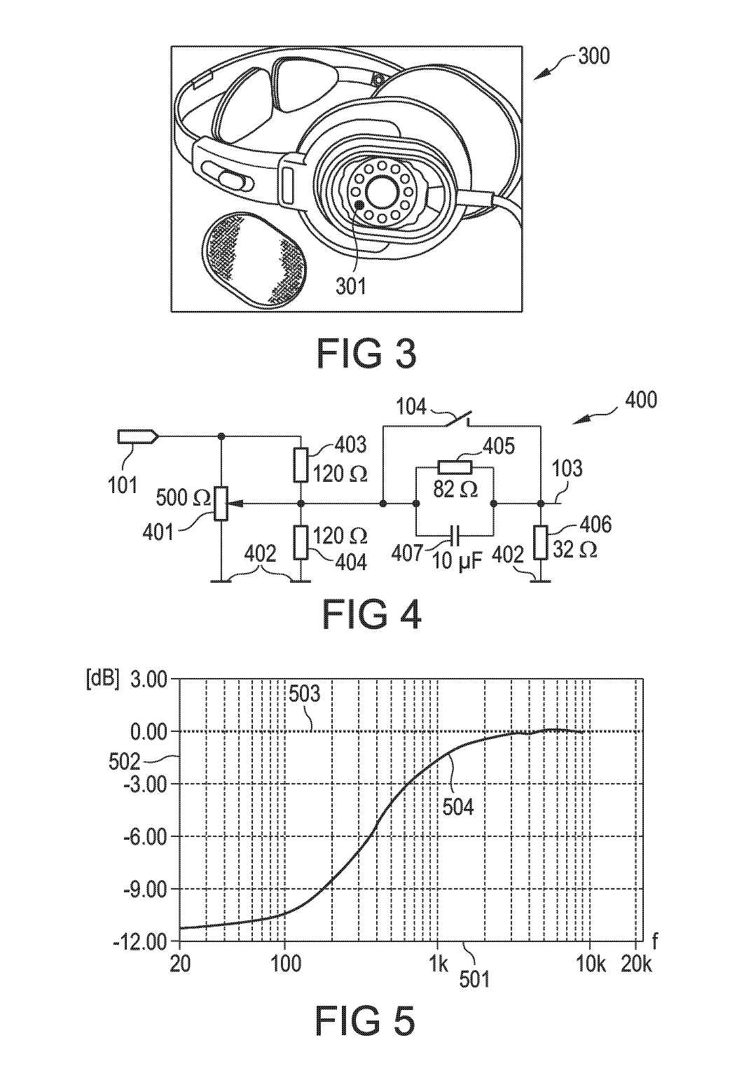

In the following, referring to FIG. 3, headphones 300 according to an embodiment of the invention will be described.

The headphones 300 shown in FIG. 3 include a bass vent 301 as a means for uplifting a low frequency component of audio data.

Particularly, FIG. 3 shows a headphone 300 with a large vent 301 on the speaker driver to create a bass uplift, without loosing sensitivity. Realizing a bass uplift without loosing sensitivity can, for example, be achieved by adding a large bass vent 301 at the back of the speaker driver or in the housing at the back of the driver.

The bass response of a headphone depends primarily on how the headphone is fitted to the ear of the user. Once this response is fixed, it is possible to lift up the bass response typically by adding a large bass vent. The sound pressure at the user's eardrum is essentially proportional to the membrane displacement. At a low frequency, the membrane displacement is limited by the compression of the air volume at the back of the membrane of the speaker driver. Opening the volume at the back of the driver with a vent (which is an acoustic mass, acting only or predominantly at low frequencies) will only allow the air to decompress out of the back volume, and therefore increase the membrane displacement.

In the following, referring to FIG. 4, an electrical circuit 400 will be described which includes a volume control and a passive electrical bass cut.

As can be seen in FIG. 4, the input audio data 101 are supplied to a first connection of a potentiometer 401. A second connection of the potentiometer 402 is connected to a ground potential 402. A third connection of the potentiometer 401 is coupled to a first connection of a first resistor 403 and to a first connection of a second resistor 404. A second connection of the first resistor 403 is connected to the first connection of the potentiometer 401, and a second connection of the second resistor 404 is brought to the ground potential 402. The third connection of the potentiometer 401 is further coupled with a first connection of a switch 104, a first connection of a third resistor 405 and a first connection of a capacitor 407. The third resistor 405 and the capacitor 407 are connected in parallel. A second connection of the switch 104, a second connection of the third resistor 405 and a second connection of the capacitor 407 are coupled to a first connection of a forth resistor 406 having a second connection which is brought to the ground potential 402. The second connections of the switch 104, of the resistor 405 and of the capacitor 407 are coupled with an output of the electrical circuit 400 at which partially processed audio data 103 are provided.

The electrical circuit 400 is realized in passive electrical circuitry.

The potentiometer 401 acts as a volume control potentiometer via which a user can adjust the loudness of audio data to be output. When the switch 104 is open (as shown in FIG. 4), then the bass boost function is switched “off”. When the switch 104 is closed (not shown), the bass boost function is switched “on”. The output audio data 106 are provided to a speaker driver unit (not shown).

The electrical bass cut is realized by the third resistor 405 in combination with the capacitor 407 and the forth resistor 406 (which may be considered to represent the headphone driver). Thus, a so-called shelving filter is formed, which leaves mid and high frequencies left untouched, but bass frequencies are attenuated by approximately 11 dB. When the switch 104 is closed, the shelving filter is bypassed and the electrical response is flat.

The first and second resistors 403, 404 are added around the volume control potentiometer 401 in order to reduce the influence of the output impedance for the shelving filter.

In the following, referring to FIG. 5, a diagram 500 will be illustrated showing the influence of the shelving filter according to FIG. 4.

Along an abscissa 501 of the diagram 500, the frequency of audio data is plotted on a logarithmic scale. Along an ordinate 502, attenuation is plotted in dB. A first curve 503 illustrates the frequency response of the circuit 400 when the shelving filter is bypassed by closing the switch 104. A second curve 504 shows the frequency response when opening the switch 104 activates the shelving filter of FIG. 4.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. A device (100) for processing audio data (101),
wherein the device (100) comprises
an uplifting means (102) adapted for uplifting a low-frequency component of the audio data (101);
an adjustment means (109) adapted for selectively adjusting an attenuation of the low-frequency component of the audio data (101).

2. The device (100) according to claim 1,
comprising a reproduction means (107) adapted for reproducing processed audio data (106).

3. The device (100) according to claim 1,
being adapted as a passive electrical circuit (400).

4. The device (100) according to claim 1,
being adapted as a headphone.

5. The device (100) according to claim 1,
being adapted to be electrically coupled with a control device (110) for providing energy for operating the device (100) and for providing the audio data (101).

6. The device (100) according to claim 1,
wherein the uplifting means (102) is realized as physical uplifting means.

7. The device (100) according to claim 1,
wherein the uplifting means (102) is realized as an acoustic mass acting predominantly on the low-frequency component of the audio data (101).

8. The device (100) according to claim 1,
wherein the uplifting means (102) is realized as a vent provided in the device (100).

9. The device (100) according to claim 2,
wherein the uplifting means (102) is realized as a vent (301) provided in the reproduction means (300).

10. The device (100) according to claim 1,
comprising a user interface (108) adapted to allow a user to adjust an attenuation of the low-frequency component of the audio data (101).

11. The device (100) according to claim 1,
wherein the adjustment means (109) is adapted for selectively switching on or switching off an attenuation of the low-frequency component of the audio data (101).

12. The device (100) according to claim 1,
wherein the adjustment means (109) is adapted for selecting an attenuation of the low-frequency component of the audio data (101) in a stepless manner or in a stepped manner.

13. The device (100) according to claim 1,
wherein the adjustment means (109) is realized including a high-pass filter or a shelving filter (105).

14. The device (100) according to claim 4,
wherein the headphones (300) comprise a cord (111) and/or an earshell, and wherein the user interface (108) is provided at the cord (111) or at the earshell of the headphones (300).

15. The device (100) according to claim 4,
wherein the headphones (300) comprise a cord (111) and/or an earshell, and wherein the adjustment means (109) is provided at the cord (111) or at the earshell of the headphones (300).

16. The device (100) according to claim 1,
realized as one of the group consisting of a portable audio player, a portable video player, a head mounted display, a mobile phone, a body-worn device, a DVD player, a CD player, a harddisk-based media player, an internet radio device, a public entertainment device, and an MP3 player.

17. A method of processing audio data (101),
wherein the method comprises the steps of
uplifting a low-frequency component of the audio data (101); and
selectively adjusting an attenuation of the low-frequency component of the audio data (101).

18. A computer-readable medium, in which a computer program of processing audio data (101) is stored which computer program, when being executed by a processor, is adapted to control the following method steps
uplifting a low-frequency component of the audio data (101);
selectively adjusting an attenuation of the low-frequency component of the audio data (101).

19. A program element of processing audio data (101), which program element, when being executed by a processor, is adapted to control the method steps of
uplifting a low-frequency component of the audio data (101);
selectively adjusting an attenuation of the low-frequency component of the audio data (101).
